(19) United States
(12) Patent Application Publication
(10) Pub. No.: US 2009/0083921 A1
(43) Pub. Date: Apr. 2, 2009

(54) Apparatus for cleaning ducts

(76) Inventor: Edward Williams, Niagara Falls, NY (US)

Correspondence Address: Robert P. Simpson;Simpson & Simpson, PLLC, 5555 Main Street, Williamsville, NY, 14221, US

(21) Appl. No.: 11/906,359

(22) Filed: Oct. 2, 2007

(51) Int. Cl. B08B 9/04

(52) U.S. Cl. 15/104.16

(57) ABSTRACT

A duct cleaning apparatus, including a flexible shaft having a first end and a second end, a cleaning head including a plurality of cleaning elements intertwined with a twisted wire, wherein each of the cleaning elements comprises a strip of electrostatic cloth fabric, and the cleaning elements extend outwardly and non-uniformly from the twisted wire, a detachable mounting assembly operatively arranged to secure the cleaning head to the first end of the flexible shaft, and wherein the flexible shaft includes a detachable connection means operatively arranged to connect the first end to the second end.

### FIELD OF THE INVENTION

The present invention relates generally to cleaning apparatuses, and more specifically to duct cleaning apparatuses.

### BACKGROUND OF THE INVENTION

Apparatuses for cleaning ducts are known in the art. U.S. Pat. No. 5,383,243 (Thacker et al.) teaches a duct brush for cleaning HVAC ducts which includes a flexible hose and a variably openable cleaning head. However, the cleaning head on the brush taught by Thacker et al. is not detachably secured, and the brush cleaning swabs are not disposable. Furthermore, the cleaning swabs originate from the mouth of the flexible hose, and must be fanned outward at an angle to reach the walls of the duct to be cleaned, thus limiting the amount of surface area in contact with the walls of the duct to only the tips of the swabs.

Thus, there is a need for a duct cleaning apparatus which includes a detachable and disposable cleaning head that has a large surface area for more effectively cleaning ducts.

### BRIEF SUMMARY OF THE INVENTION

The present invention broadly comprises a duct cleaning apparatus, including a flexible shaft having a first end and a second end, a cleaning head including a plurality of cleaning elements intertwined with a twisted wire, wherein each of the cleaning elements comprises a strip of electrostatic cloth fabric, and the cleaning elements extend outwardly and non-uniformly from the twisted wire, a detachable mounting assembly operatively arranged to secure the cleaning head to the first end of the flexible shaft, and wherein the flexible shaft includes a detachable connection means operatively arranged to connect the first end to the second end.

A general object of the invention is to provide a duct cleaning apparatus having a cleaning head with a plurality of non-uniform cleaning elements arranged to clean large surface areas of the ducts, where the cleaning head is easily detachable from the apparatus for cleaning and/or replacement of the cleaning elements.

Another object of the invention is to provide a duct cleaning apparatus having a flexible shaft for easy installation and bending in ductwork.

A further object of the invention is to provide a duct cleaning apparatus having electrostatic cloth cleaning elements.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a fragmentary perspective view of the duct cleaning apparatus of the present invention;

FIG. 2 is an exploded view of the duct cleaning apparatus shown in FIG. 1;

FIG. 3 is a perspective view showing a first flexible shaft attaching to a second flexible shaft to create a double-length duct cleaning apparatus;

FIG. 4 is a cross-sectional view of the mounting assembly of the invention taken generally along line 4-4 in FIG. 1; and,

FIGS. 5-8 show the duct cleaning apparatus of FIG. 1 being progressively inserted into a duct for cleaning.

### DETAILED DESCRIPTION OF THE INVENTION

At the outset, it should be appreciated that like drawing numbers on different drawing views identify identical, or functionally similar, structural elements of the invention.

While the present invention is described with respect to what is presently considered to be the preferred aspects, it is to be understood that the invention as claimed is not limited to the disclosed aspects. Also, the adjectives, “top,” “bottom,” “right,” “left,” and their derivatives, in the description herebelow, refer to the perspective of one facing the invention as shown in the figure under discussion.

Furthermore, it should be understood that this invention is not limited to the particular methodology, materials and modifications described and as such may, of course, vary. It should also be understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

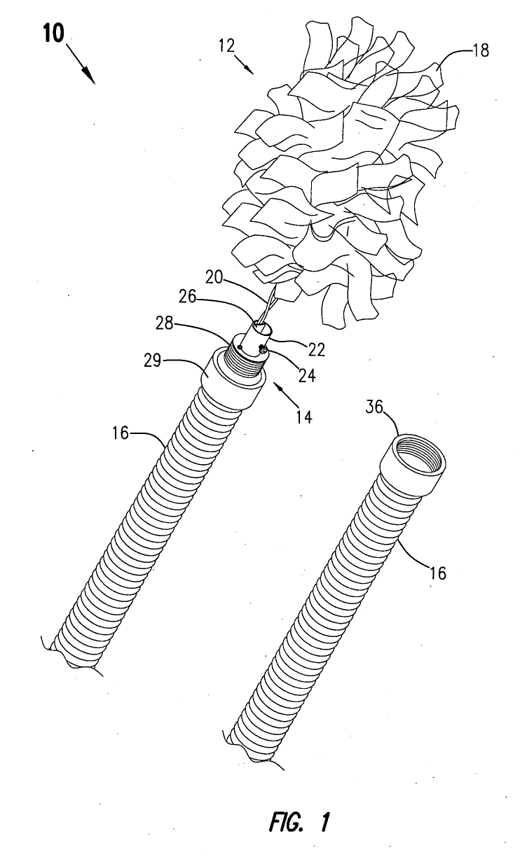

Adverting now to the drawings, FIG. 1 is a perspective view of duct cleaning apparatus 10. Duct cleaning apparatus 10 includes cleaning head 12, mounting assembly 14, and flexible shaft 16. In a preferred embodiment flexible shaft 16 is a hollow corrugated hose, but in other embodiments the hose does not have to be hollow or corrugated, as long as the shaft has sufficient flexibility to maneuver through a duct. Also, flexible shaft 16 has enough rigidity so that it can be inserted into a duct, and will not simply fold in on itself when it is inserted into a duct. The flexible shaft has two ends, with one end terminating in mounting assembly 14, and the other end terminating in threaded collar 36, as shown.

Cleaning head 12 includes a plurality of cleaning elements 18. Plurality of cleaning elements 18 may be woven or non-woven sheets made from strips of cloth or a similar cleaning material. As described in U.S. Pat. No. 6,777,064, “The use of nonwoven sheets for dry dust-type cleaning are known in the art. Such sheets typically utilize a composite of fibers where the fibers are bonded via adhesive, entangling or other forces. See, for example, U.S. Pat. No. 3,629,047 and U.S. Pat. No. 5,144,729. To provide a durable wiping sheet, reinforcement means have been combined with the staple fibers in the form of a continuous filament or network structure. See, for example, U.S. Pat. Nos. 4,808,467, 3,494,821 and 4,144,370. Also, to provide a product capable of withstanding the rigors of the wiping process, prior nonwoven sheets have employed strongly bonded fibers via one or more of the forces mentioned above. While durable materials are obtained, such strong bonding may adversely impact the materials' ability to pick up and retain particulate dirt. In an effort to address this concern, U.S. Pat. No. 5,525,397 to Shizuno et al. describes a cleaning sheet comprising a polymeric network layer and at least one nonwoven layer, wherein the two layers are lightly hydroentangled so as to provide a sheet having a low entanglement coefficient. The resulting sheet is said to provide strength and durability, as well as improved dust collecting performance because the composite fibers are lightly hydroentangled. Sheets having a low entanglement coefficient (i.e., not more than 500 m) are said to offer better cleaning performance because a greater degree of fibers are available for contact with dirt. While the sheets described in the '397 patent are alleged to address some of the problems with prior nonwoven cleaning sheets, those sheets appear to be generally of a uniform basis weight, at least on a macroscopic level; and are essentially of a uniform caliper, again on a macroscopic level. That is, ordinary and expected basis weight and caliper fluctuations and variations may occur on a random basis, as a result of fluid pressure differentials during hydroentanglement. However, the structure would not be deemed to comprise discrete regions that differ with regard to basis weight. For example, if on a microscopic level, the basis weight of an interstice between fibers were measured, an apparent basis weight of zero would result when, in fact, unless an aperture in the nonwoven structure was being measured, the basis weight of such region is greater than zero. Such fluctuations and variations are a normal and expected result of the hydroentangling process. The skilled artisan would interpret nonwovens having such variations, including those described in the '397 patent, as having essentially a uniform basis weight and caliper, in the macroscopic sense. The result of a sheet having a uniform basis weight is that the material is not particularly suitable for collecting and entrapping soil of a diverse size, shape, and the like.” In a preferred embodiment of the present invention, any of the cleaning sheets mentioned in the above-identified patents are suitable for use in the invention. So called “electrostatic cloth” is preferred because it attracts dust and allergens without the need of coating or impregnating the cleaning elements with cleaning chemicals. An example of a suitable cleaning element would be “Swiffer” brand cleaning cloths manufactured by Proctor & Gamble. However, in another embodiment, furniture polish or scented oil may be applied to the cleaning elements so that, after cleaning, the airflow through the duct will spread the fragrance of the polish or oil throughout the building that contains the duct.

In a preferred embodiment, the cleaning elements are intertwined in twisted wire 20, extending outwardly from the twisted wire so that the cleaning elements are non-uniformly distributed about the twisted wire. By intertwined we mean that the wire is tightly twisted around a portion of the cleaning elements to secure them to the cleaning head. By non-uniformly, we mean that although the elements are generally orientated outwardly; the cleaning elements are randomly arranged about the twisted wire at different angles, and cleaning elements are of a variety of size and shape. The large number of non-uniformly distributed cleaning elements increases the amount of potential surface area on all sides of cleaning head 12 to collect dust. Twisted wire 20 can be a single wire which is folded back onto itself, or a plurality of wires proximate each other. Furthermore, in a preferred embodiment, twisted wire 20 is made of metal, but can be made of any suitable material in other embodiments.

Mounting assembly 14 is secured to one end of flexible shaft 16. The mounting assembly detachably secures cleaning head 12 onto flexible shaft 16. Mounting assembly 14 includes clamping device 22. In a preferred embodiment clamping device 22 is a generally hollow cylinder which includes screw 24 for tightening plate 26 against the interior of the clamping device. The clamping device is used to detachably secure the cleaning head to the flexible shaft. It should be appreciated that this only describes one assembly for detachably securing the cleaning head to the flexible shaft. In other embodiments, the clamping device may be replaced with a set of spring-loaded jaws, an elastic cord, screws, temporary adhesives, or any other method known in the art for detachably securing two pieces together.

In a preferred embodiment, mounting assembly 14 further includes threaded protrusion 28. Threaded protrusion 28 is affixed to collar 29, which secures mounting assembly 14 onto flexible shaft 16. Threaded protrusion 28 provides an additional mounting function for the mounting assembly, which will be described infra.

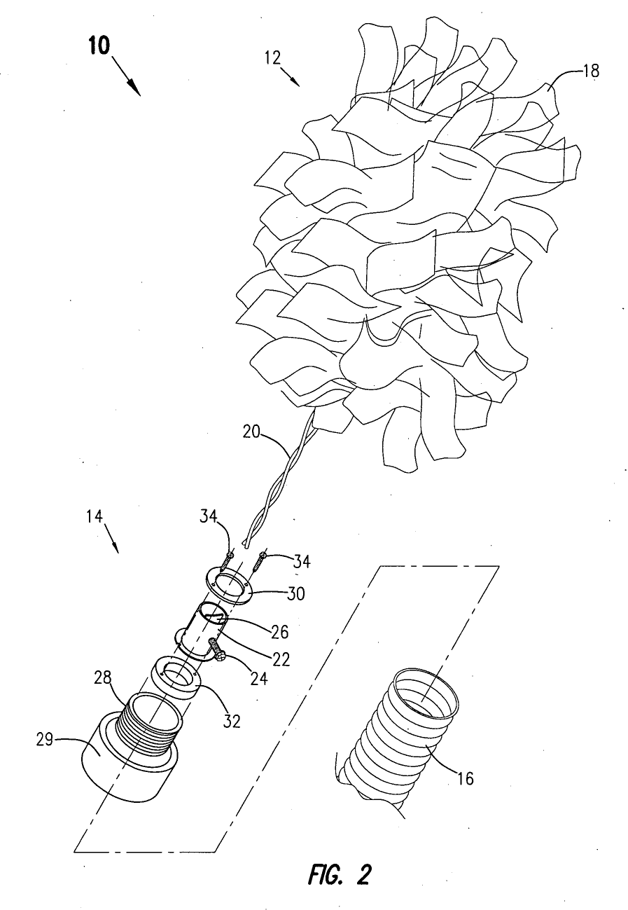

FIG. 2 is an exploded view of duct cleaning apparatus 10. In a preferred embodiment, as shown, mounting assembly 14 further includes mounting rings 30 and 32, and screws 34. In a preferred embodiment mounting ring 32 presses tightly inside threaded protrusion 28. In another embodiment, screws (not shown) are drilled through the mounting ring and through the walls of flexible shaft 16 to hold mounting ring 32 in place. Clamping device 22 sits between mounting ring 32 and mounting ring 30 and is firmly secured in place by screws 34. The screws thread through corresponding holes in the mounting rings. Threaded protrusion 28 is affixed to collar 29, which fits over one end of flexible shaft 16 to secure the shaft to the mounting assembly.

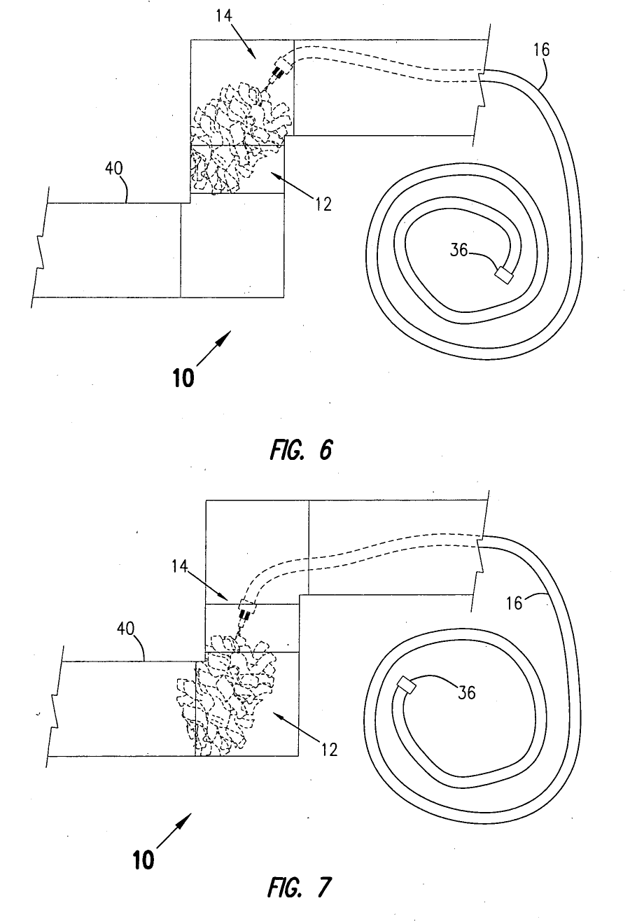

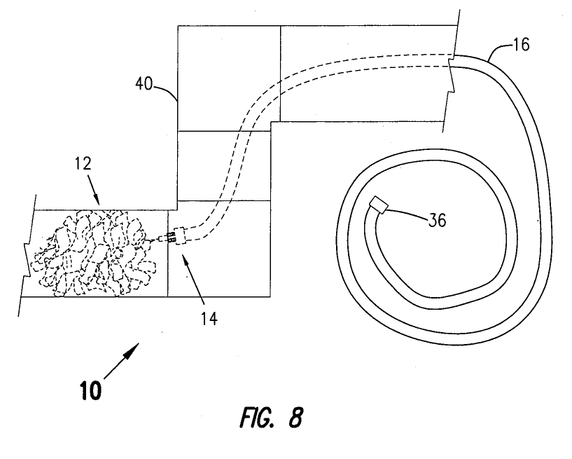

It should be clear to one of ordinary skill in the art that FIGS. 1-8 illustrate only one embodiment of the current invention, and that, of course, other methods may work similarly without departing from the scope and spirit of the present invention. For example, screws 34 may be replaced with rivets, nails, adhesives, or the like. Furthermore, the mounting rings may be replaced by a sufficiently sized flange circumferentially located about the clamping device. Additionally, the entire mounting assembly may be detachably or fixedly secured to the flexible shaft by any means known in the art.

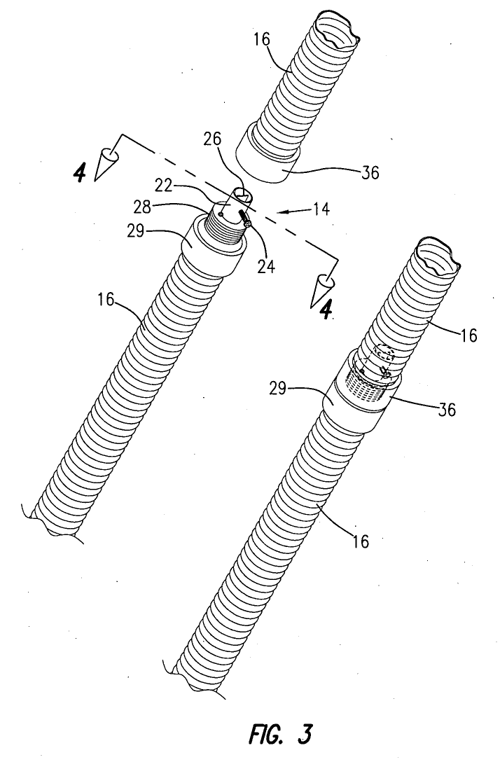

FIG. 3 is a perspective view showing a first flexible shaft 16 attaching to a second flexible shaft 16 to effectively double the length of the present invention duct cleaning apparatus. Threaded protrusion 28 on the first flexible shaft engages with threaded collar 36 on the second flexible shaft. This safely houses the mounting assembly inside of the second flexible shaft 16. In alternate embodiments, the mounting device may detachably securable, so that it can be removed from one shaft when two flexible shafts 16 are attached. It should be appreciated that threaded collar 36 and threaded protrusion 28 could be replaced with other detachable connection means, such as bolts, clamps, temporary adhesives, or the like.

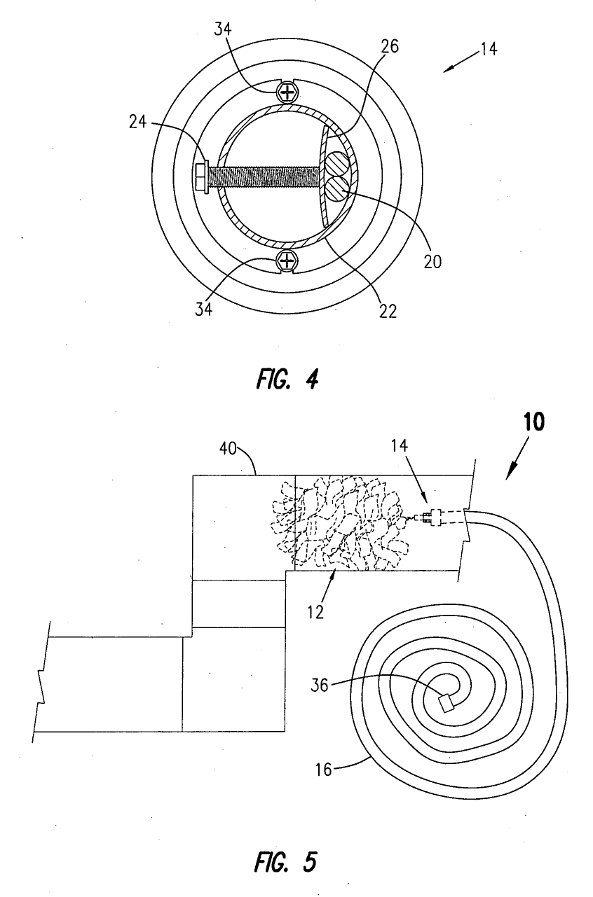

FIG. 4 is a cross-sectional view of mounting assembly 14 taken generally along line 4-4 in FIG. 1, which illustrates clamp screw 24 operatively arranged to control the position of plate 26 within clamping device 22 so that twisted wire 20 can be clamped in place or released from the mounting assembly. It is important for the mounting assembly to quickly and easily secure and release the cleaning head, because in a preferred embodiment the cleaning head is disposable. Once the cleaning elements on the cleaning head are sufficiently soiled from cleaning ducts, the user has the option to clean the head or to simply dispose of and replace the cleaning head. As discussed supra, mounting assembly 14 provides a fast and simple way to replace a cleaning head.

FIGS. 5-8 illustrate duct cleaning apparatus 10 as it is inserted into air duct 40. In a preferred embodiment the cleaning head is operatively arranged so that it touches every wall of the duct. Duct 40 is a representative air duct, so it could be any duct known in the art, and therefore may have a circular, rectangular, or any other cross-sectional shape. Duct 40 is illustrated having two closely oriented ninety degree bends to demonstrate that the flexible shaft of the duct cleaning apparatus can bend so that the apparatus can be inserted deep into ducts, such as duct 40, regardless of bends, turns, or corners.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A duct cleaning apparatus, comprising:
a flexible shaft;
a cleaning head comprising a plurality of cleaning elements, wherein each of said cleaning elements comprises a strip of cloth fabric, and said plurality of cleaning elements is arranged non-uniformly; and,
a detachable mounting assembly operatively arranged to secure said cleaning head to said flexible shaft.

2. The duct cleaning apparatus recited in claim 1 wherein said cleaning elements are electrostatic cloth strips of varied sizes and shapes.

3. The duct cleaning apparatus recited in claim 1 wherein said cleaning elements are coated in scented oil.

4. The duct cleaning apparatus recited in claim 1 wherein said cleaning elements are non-woven sheets of cloth.

5. The duct cleaning apparatus recited in claim 1 wherein said mounting assembly comprises a clamp which includes a threaded screw for tightening a moveable plate.

6. The duct cleaning apparatus recited in claim 1 wherein said flexible shaft is a hollow, corrugated hose.

7. A duct cleaning apparatus, comprising:
a flexible shaft;
a cleaning head including a plurality of cleaning elements intertwined with a twisted wire, wherein each of said cleaning elements comprises a strip of cloth fabric, and said cleaning elements extend outwardly and non-uniformly from said twisted wire; and,
a detachable mounting assembly operatively arranged to secure said cleaning head to said flexible shaft.

8. The duct cleaning apparatus recited in claim 7 wherein said cleaning elements are electrostatic.

9. A duct cleaning apparatus, comprising:
a flexible shaft having a first end and a second end;
a cleaning head including a plurality of cleaning elements intertwined with a twisted wire, wherein each of said cleaning elements comprises a strip of electrostatic cloth fabric, and said cleaning elements extend outwardly and non-uniformly from said twisted wire;
a detachable mounting assembly operatively arranged to secure said cleaning head to said first end of said flexible shaft; and,
wherein said flexible shaft includes a detachable connection means operatively arranged to connect said first end to said second end.

10. The duct cleaning apparatus recited in claim 9 wherein said connection means comprises complementarily threading on said first end and said second end of said flexible shaft.
